(19) United States
(12) Patent Application Publication
(10) Pub. No.: US 2012/0315080 A1
(43) Pub. Date: Dec. 13, 2012

(54) SLIDING CLOSURE

(76) Inventor: STEPHAN ZINK, Erlangen (DE)

(21) Appl. No.: 13/491,365

(22) Filed: Jun. 7, 2012

(30) Foreign Application Priority Data
Jun. 8, 2011 (DE) 10 2011 077 208.1

(51) Int. Cl. F16B 7/14; F16B 7/10

(52) U.S. Cl. 403/110; 403/52

(57) ABSTRACT

A belt fastening device for fastening a holder for a belt in a groove of a patient couch for an imaging device includes a slider that may be displaced relative to the holder of the belt fastening device from a first position in a first direction into a second position. The slider may be displaced in a second direction opposing the first direction from the second position into the first position.

This application claims the benefit of DE 10 2011 077 208.1, filed on Jun. 8, 2011.

### BACKGROUND

The present embodiments relate to a magnetic resonance tomography (MRT) local coil for an MRT system.

Magnetic resonance tomography devices for examining objects or patients by magnetic resonance tomography (MRT, MRI) are described, for example, in DE 10314215B4 and DE 102010002393.0.

### SUMMARY

The present embodiments may obviate one or more of the drawbacks or limitations in the related art. For example, a belt fastening device for fastening a holder for a belt for a magnetic resonance tomography device may be further optimized.

The present embodiments provide an optimization of an MRT belt fastening device in an alternative manner to known belts.

### BRIEF DESCRIPTION OF THE DRAWINGS

FIGS. 1 a-c show a front perspective view, a top perspective view, and an enlarged view, respectively, of one embodiment of a fastening device in an open fastening position;

FIGS. 2 a-c show three views of one embodiment of the fastening device of FIG. 1 in a closed fastening position;

FIGS. 3 a-b show side views of one embodiment of a fastening device in a longitudinal groove of a patient couch in an open fastening position and in a closed fastening position;

FIG. 4 shows a side view of one embodiment of a belt fastening device in a longitudinal groove of a patient couch;

FIG. 5 shows a perspective view of one embodiment of a fastening device in a longitudinal groove of a patient couch; and

FIG. 6 shows a magnetic resonance tomography (MRT) system with a patient couch.

### DETAILED DESCRIPTION OF THE DRAWINGS

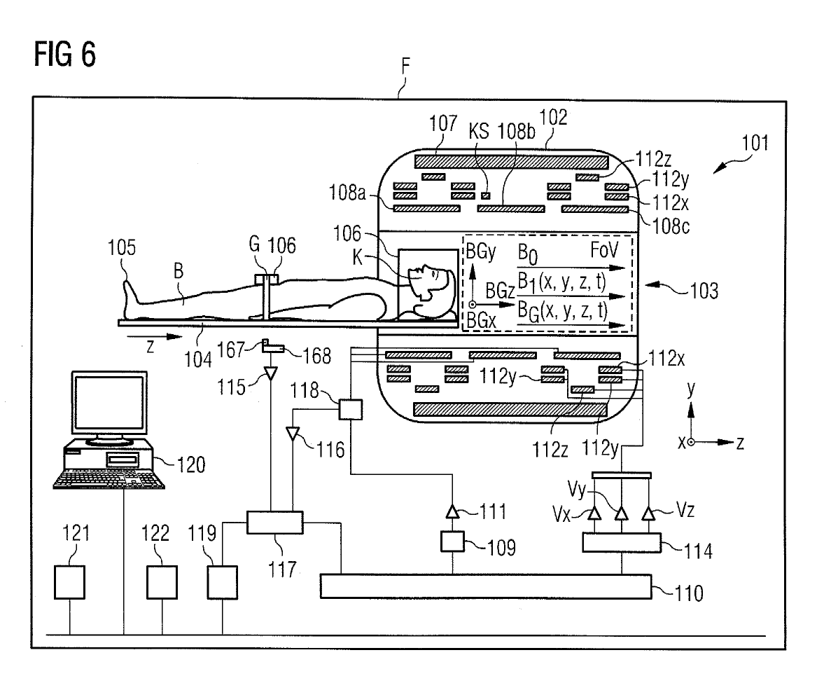

FIG. 6 shows an imaging magnetic resonance tomography (MRT) device 101 (e.g., located in a shielded chamber or Faraday cage F) including a whole body coil 102 with a chamber 103 (e.g., a tubular chamber), into which a patient couch 104 with a body 105 (e.g., an object to be examined such as a patient; with or without a local coil arrangement 106) may be moved in the direction of the arrow z, in order to generate recordings of the patient 105 using an imaging method. The local coil arrangement 106 (e.g., fastened to the belt or a further belt) is arranged on the patient (optionally fastened by a belt). Recordings may be generated in a local region of the MRT device 101 (e.g., the field of view (FOV)) by the local coil arrangement 106 of a partial region of the body 105 in the FOV. Signals of the local coil arrangement 106 may be evaluated (e.g., converted into images, stored or displayed) by an evaluation device (e.g., including elements 168, 115, 117, 119, 120, and 121) of the MRT device 101. The evaluation device may be connected to the local coil arrangement 106, for example, via coaxial cables or via radio (167).

In order to examine the body 105 (e.g., the object to be examined or the patient) using the magnetic resonance device MRT device 101, using magnetic resonance imaging, different magnetic fields that are aligned with one another as precisely as possible in terms of temporal and spatial characteristics are radiated onto the body 105. A powerful magnet (e.g., a cryomagnet 107) in a measuring booth with an opening 103 that is, for example, tunnel-shaped generates a static, powerful main magnetic field B₀ that ranges, for example, from 0.2 Tesla to 3 Tesla or more. The body 105 to be examined and positioned on the patient couch 104 is moved into an approximately homogenous region of the main magnetic field B₀ in the FoV. An excitation of the nuclear spins of atomic nuclei of the body 105 takes place via magnetic high frequency excitation pulses B1 (x, y, z, t) that are radiated via a high frequency antenna (and/or optionally a local coil arrangement) shown in simplified form in FIG. 6 as a body coil 108 (e.g., a multi-part coil 108a, 108b, 108c). High frequency excitation pulses are, for example, generated by a pulse generating unit 109 that is controlled by a pulse sequence control unit 110. After amplification by a high frequency amplifier 111, the high frequency excitation pulses are forwarded to the high frequency antenna 108. The high frequency system shown in FIG. 6 is only indicated schematically. In other embodiments, more than one pulse generating unit 109, more than one high frequency amplifier 111 and a plurality of high frequency antennas 108, a, b, c are used in a magnetic resonance device 101.

The magnetic resonance device 101 also has gradient coils 112x, 112y, 112z, with which, during a measuring procedure, magnetic gradient fields are radiated for selective layer excitation and for position encoding of the measured signal. The gradient coils 112x, 112y, 112z are controlled by a gradient coil control unit 114 that, as in the case of the pulse generating unit 109, is connected to the pulse sequence control unit 110.

Signals transmitted by the excited nuclear spins (of the atomic nuclei in the object to be examined) are received by the body coil 108 and/or at least one local coil arrangement 106, amplified by associated high frequency pre-amplifiers 116 and processed further and digitized by a receiving unit 117. The recorded measured data is digitized and stored as complex numerical values in a k-space matrix. An associated MR image may be reconstructed from the k-space matrix populated with values using a multi-dimensional Fourier transformation.

For a coil that may be operated both in transmission mode and in receiving mode (e.g., the body coil 108 or the local coil 106), correct signal forwarding is controlled by a transmission-receiving switch 118 arranged upstream.

An image processing unit 119 generates, from the measured data, an image that is displayed via a control panel 120 to a user and/or stored in a storage unit 121. A central computing unit 122 controls the individual system components.

In MR tomography, images with a high signal/noise ratio (SNR) may be recorded using local coil arrangements (e.g., coils, local coils). The local coil arrangements are antenna systems that are connected in the immediate vicinity onto (anterior), below (posterior), on, or in the body 105. During an MR measurement, the excited nuclei induce a voltage in the individual antennas of the local coil. The induced voltage is amplified by a low-noise pre-amplifier (e.g., LNA, preamp) and forwarded to the receiving electronic devices. For improving the signal/noise ratio, even with high-resolution images, high field systems are used (e.g., 1.5 T or more). If more individual antennas may be connected to an MR receiving system than are present as receivers, for example, a switching matrix (e.g., RCCS) is fitted between the receiving antennas and the receiver. The switching matrix routes the currently active receiving channels (e.g., the receiving channels that are located in the field of view of the magnet) to the receivers that are present. As a result, more coil elements than there are receivers may be connected. As with whole body coverage, only the coils that are located in the FoV and/or in the homogeneity volume of the magnet have to be read.

An antenna system may be denoted as a local coil arrangement 106. The antenna system may include, for example, one antenna element or an array of coils including a plurality of antenna elements (e.g., coil elements). The individual antenna elements are, for example, configured as loop antennas (e.g., loops), butterfly coils, flexible coils or saddle coils. A local coil arrangement includes, for example, coil elements, a pre-amplifier, further electronic devices (e.g., sheath wave barriers), a housing, supports and may include a cable with a plug, by which the local coil arrangement is connected to the MRT system. A receiver 168, connected on the system side, filters and digitizes a signal received from a local coil 106, for example, via radio and transmits the data to a digital signal processing device. The digital signal processing device may derive an image or a spectrum from the data obtained by a measurement and may make the image or spectrum available to the user, for example, for subsequent diagnosis by the user and/or for storage.

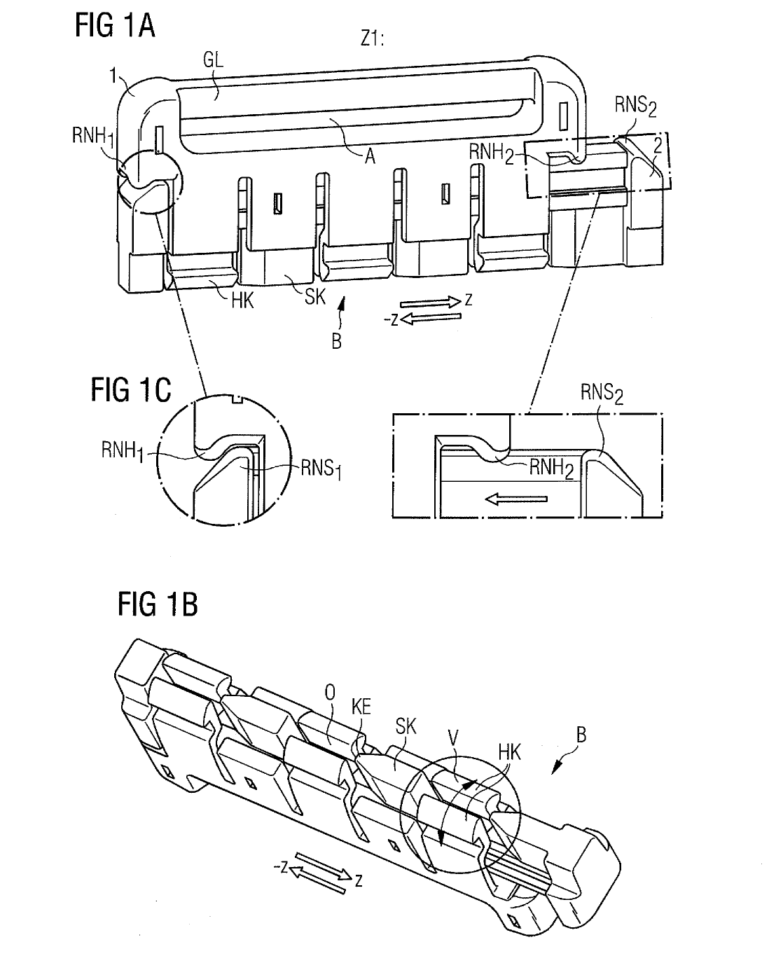

Exemplary embodiments of MRT local coils are described in more detail below with reference to FIGS. 1-5.

An object to be examined (e.g., a patient 105) may be examined in an MRT device 101 lying on a patient couch 104, for example, by using a local coil 106 on the head K, above the stomach or on a different body part.

The patient 105 and/or a medical device (e.g., a local coil 106) may be fixed onto the MR patient couch 104, for example, via one or more belts G according to the figures.

A belt G may, for example, extend through a recess A of a fastening unit B (e.g., also on both sides of the patient couch) and/or bear against (e.g., press against, and/or contact) a belt strap GL of the belt fastening device B.

The fastening device B for the belt G (hereinafter also referred to as the belt fastening device or patient couch belt fastening device) may be inserted into and removed from a groove (e.g., a longitudinal groove 104N extending in a first direction such as the +z direction and/or −z direction), for example, at an open end of the longitudinal groove 104N according to FIG. 5, and/or the fastening device for the belt G may also be inserted and removed by inserting the fastening device B at any point of the longitudinal groove 104N (e.g., in the shape of a T-shaped groove) by, for example, resilient blocking.

The belt G (viewed in a plan view of the patient couch from above, counter to the y direction) may be anchored laterally in the patient couch 104 (e.g., the groove of the patient couch) and may be simple in terms of handling/operation.

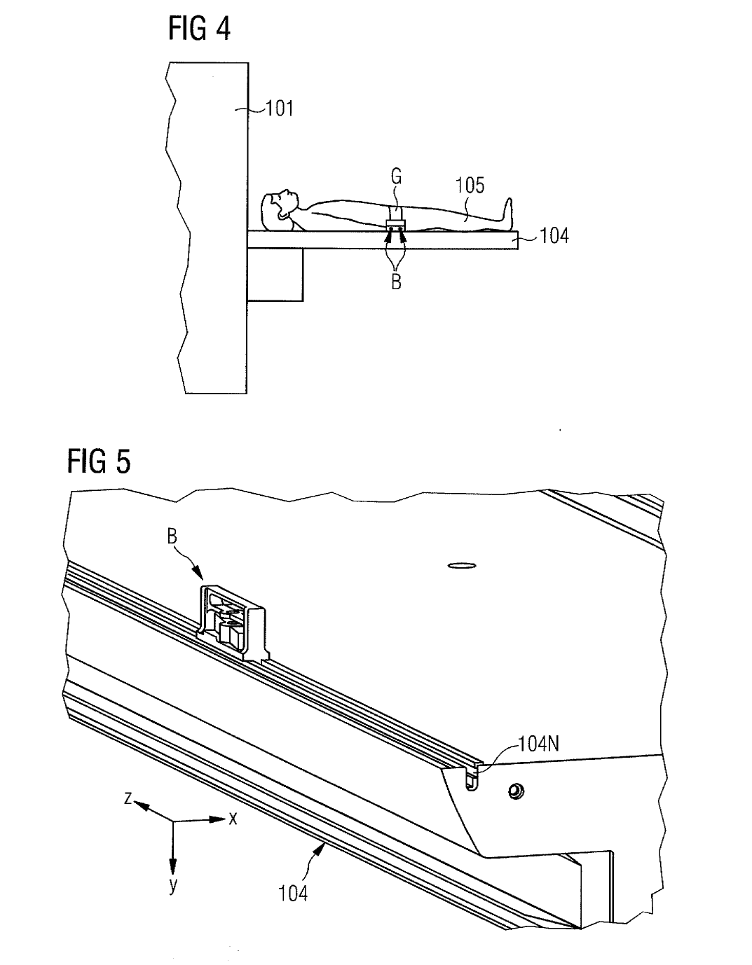

A system according to FIG. 4 and DE102010002393.0 uses a closure mechanism that is inserted in a defined position into a T-shaped groove and is locked to the belt by a 90 degree rotation of the connecting part.

An embodiment of a sliding closure with a fastening device B includes, for example, two elements 1, 2, according to FIGS. 1-3, for example. A first element 1 of the two elements is or includes, for example, a holder 1 (e.g., with a belt strap GL) as the fastening point for the belt G with clamping catches HK connected thereto. The clamping catches HK are configured to be able to dip into a groove 104N of a patient couch.

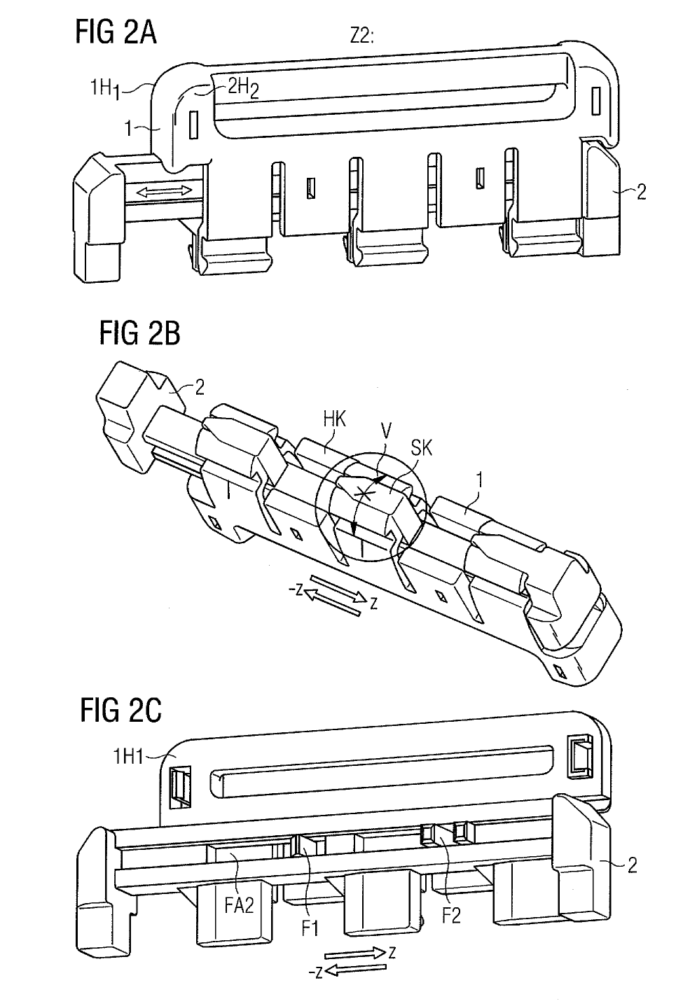

A second element 2 of the two elements is or includes at least one slider 2 that may be displaced relative to the holder 1 in the longitudinal direction z thereof (e.g., in and counter to the first direction=−z direction and/or in the direction in which the holder 1 may be displaced in a groove and/or in the direction in which the holder 1 is longest). According to a position relative to the holder 1, the slider 2 releases the clamping catches HK (e.g., in the position in FIG. 1, with the slider 2 partially pulled out of the holder 1 to the right (+z)) or blocks the clamping catches (e.g., in the position in FIG. 2, with the slider 2 pushed to the left (−z) in the holder 1). In the exemplary embodiments shown in FIGS. 1-3, parts (SK) of the slider 2 may be displaced inside parts (HK) of the holder 1. In this case, clamping regions SK of the slider 2 viewed in the x direction or in plan view according to FIGS. 1b, 2b, may be displaced inside clamping catches HK of the holder 1. The clamping regions SK of the slider may also, for example, be displaced between clamping catches HK into an open state Z1 according to FIG. 1 and may be displaced into a closed state Z2 according to FIG. 2, bearing against (e.g., pressing against and/or in contact with) the clamping catches HK.

Clamping regions SK (e.g., clamping elements or sliding clamping elements) are, for example, rounded and/or beveled and/or wedge-shaped (KE) in order to facilitate insertion (z) of the clamping regions SK of the slider 2 in a first direction (e.g., the “−z” direction) between the clamping catches HK of the holder 1.

The clamping catches HK (e.g., clamping clips or retaining clamping elements) of the holder 1 are, for example, resilient (e.g., made of resilient plastics) in order to facilitate insertion (z) of the clamping regions SK of the slider 2 in the z direction between clamping catches HK of the holder 1.

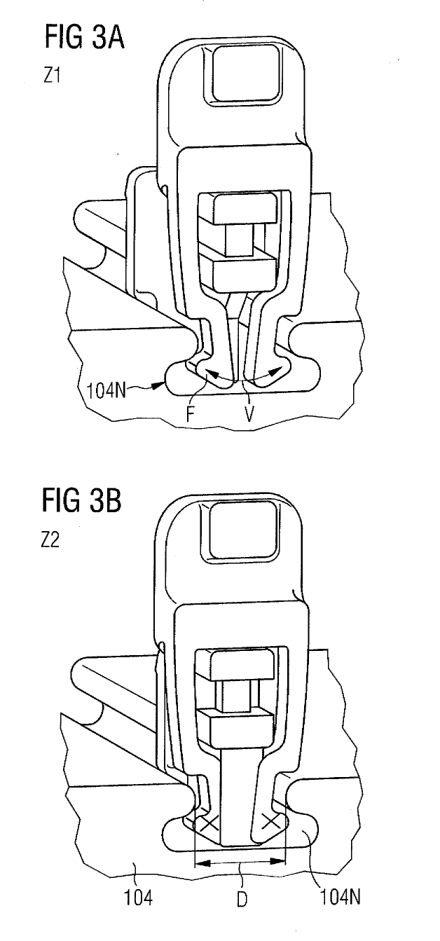

In an open position (e.g., in the open state 1) of the fastening device B (according to the views in FIG. 1), open regions O (e.g., discontinuous regions or regions without clamping regions SK) of the slider 2 oppose clamping catches HK of the holder 1, and/or clamping regions SK (or clamping elements) of the slider 2 are located (e.g., without bearing/contact) in the z direction between clamping catches. The clamping catches HK of the holder 1 are movable (e.g., “freely” or slightly movable; slightly resiliently displaceable toward one another in the x direction for inserting in a patient couch longitudinal groove 104N according to FIG. 3a). The clamping catches HK may be easily inserted thereby and/or by oblique surfaces F (e.g., on outer faces of the clamping catches HK of the holder 1), as shown in FIG. 3a, into the patient couch longitudinal groove 104N of the patient couch 104.

The clamping catches HK of the holder 1 are configured such that a distance between opposing latching lugs (e.g., resilient latching lugs) of the clamping catches HK is slightly greater than the patient couch longitudinal groove 104N (e.g., as soon as the fastening device B is located in the groove of the patient couch, the fastening device B is already slightly retained, even before the closure is closed by displacing the slider into the state Z2, according to FIG. 2). A displacement of the fastening device B and thus of the belt G therein in the longitudinal direction of the patient couch longitudinal groove 104N (e.g., in the direction z) may thus be provided.

In one embodiment, the holder 1 includes a latching lug RNH1, RNH2 at each of the ends of the holder 1, according to the enlarged details (from FIG. 1a) in FIG. 1c. The open and/or the closed position of the slider 2 is blocked (e.g., in each case, by a resiliently engaging latching lug RNS1, RNS2 of the slider) with the latching lugs RNH1, RNH2. An inadvertent actuation (e.g., opening or closing) of the closure (1, 2) is thus avoided.

A closed position (e.g., a closed state Z2), according to FIG. 2, is achieved if the slider 2 is completely pushed from the open state toward the other side (in the holder 1) until the holder 1 and the slider 2 are mutually locked together (according to FIG. 2b). At least one clamping region SK of the slider 2 comes to bear (e.g., press and/or is in contact) between (e.g., at any point or exactly) the clamping catches HK of the holder 1. The clamping catches HK are pushed in a resilient manner (e.g., away from one another/in the x direction) by the slider 2 (and/or by the clamping regions SK thereof) and thus blocked against displacement. The clamping catches are hooked, according to FIGS. 3a and b, (e.g., by being spread apart from the position in FIG. 3a to the left in the direction V into the position in FIG. 3b to the right) in the patient couch longitudinal groove 104N of the patient couch 104, and the sliding closure (e.g., formed from 1, 2) is closed. In one embodiment, the clamping catches HK are pushed sufficiently far until the clamping catches HK come slightly into contact with the patient couch longitudinal groove 104N (e.g., in each case, in pairs away from one another). The sliding closure may be fixed in position and no longer be able to move in the patient couch longitudinal groove 104N.

For easier mounting of the sliding closure, the holder 1 is configured in two parts, as FIG. 2c shows in a plan view of one half 1H1 of the slider 1 (e.g., to which a second half 1H2, according to FIGS. 2a, 2b, may be fastened). The halves of the holder 1 are approximately identical or mirror-imaged and fit together when rotated by 180°. The slider 2 may be easily inserted into the holder 1H1 and is securely guided in the holder 1H1, for example, with guides F1, F2 of the holder 1 that displaceably engage in guide recesses FA1, FA2 of the slider 2.

In one embodiment, one possible advantage is in the type of closure to be actuated. The closure is operated via simple displacement (e.g., in the z direction or −z direction).

This may result in the following advantages, for example. One-handed operation is possible. Inadvertent release of the holder is avoided. Fixing of the holder according to precise alignment may be provided. Twisting of the belts is avoided, and the protrusion of components is avoided. An efficient, rapid workflow may be provided, and a greater contact area on the latching lugs may be introduced into the patient couch longitudinal groove 104N by force.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A belt fastening device for fastening a holder for a belt in a groove of a patient couch for an imaging device, the belt fastening device comprising:
a slider that is displaceable relative to the holder of the belt fastening device from a first position in a first direction into a second position, the slider also being displaceable in a second direction opposing the first direction from the second position into the first position.

2. The belt fastening device as claimed in claim 1, wherein the slider is displaceable relative to the holder of the belt fastening device in the holder in a longitudinal direction of the holder from the first position in the first direction into the second position, and
wherein the slider is displaceable in the holder in the second direction opposing the first direction from the second position into the first position.

3. The belt fastening device as claimed in claim 1, wherein the belt fastening device is a belt fastening device for fastening the holder for the belt for fixing a local coil or an object to be examined above the patient couch for a medical imaging device.

4. The belt fastening device as claimed in claim 1, wherein the holder of the belt fastening device comprises a recess for the belt, the belt extending through the recess.

5. The belt fastening device as claimed in claim 1, wherein the holder of the belt fastening device comprises elements configured for insertion into a patient couch longitudinal groove of the patient couch.

6. The belt fastening device as claimed in claim 5, wherein the elements comprise clamping catches.

7. The belt fastening device as claimed in claim 1, wherein the holder of the belt fastening device comprises elements configured for blocking in a patient couch longitudinal groove of the patient couch.

8. The belt fastening device as claimed in claim 1, wherein the elements comprise clamping catches.

9. The belt fastening device as claimed in claim 1, wherein one or more clamping regions of the slider do not contact, press against, or contact and press against clamping catches of the holder in the first position, release clamping catches of the holder in a direction at right angles to a direction of movement of the slider, or a combination thereof.

10. The belt fastening device as claimed in claim 1, wherein one or more clamping regions of the slider only contact, press against, or contact and press against clamping catches of the holder in the second position, block the clamping catches of the holder against displacement, block separate clamping catches of the holder from one another, or block the clamping catches of the holder against displacement and block separate clamping catches of the holder against displacement, or a combination thereof.

11. The belt fastening device as claimed in claim 1, wherein regions of the slider without clamping regions respectively oppose clamping catches of the holder in the first position of the slider.

12. The belt fastening device as claimed in claim 1, wherein clamping regions of the slider oppose clamping catches of the holder only in the second position of the slider.

13. The belt fastening device as claimed in claim 1, wherein two clamping catches of the holder are each configured to be moveable in a resilient manner away from one another.

14. The belt fastening device as claimed in claim 1, wherein clamping catches of the holder are configured to be resiliently displaceable toward one another.

15. The belt fastening device as claimed in claim 14, wherein the clamping catches of the holder are configured to be resiliently displaceable toward one another for inserting the belt fastening device into a patient couch longitudinal groove.

16. The belt fastening device as claimed in claim 1, wherein clamping catches of the holder comprise beveled surfaces.

17. The belt fastening device as claimed in claim 16, wherein the beveled surfaces are configured for insertion of the belt fastening device into a patient couch longitudinal groove.

18. The belt fastening device as claimed in claim 1, wherein clamping catches of the holder are configured such that a distance between external surfaces of opposing clamping catches is greater than the smallest diameter of a patient couch longitudinal groove.

19. The belt fastening device as claimed in claim 1, wherein the holder comprises a latching lug on one or both ends of the holder, an open position, a closed position, or the open position and the closed position of the slider of the belt fastening device being blockable using the latching lug.

20. The belt fastening device as claimed in claim 1, wherein the holder comprises at least two subcomponents that are fastenable together, at least one part of the slider being located between the at least two subcomponents when the at least two subcomponents are fastened together.

21. The belt fastening device as claimed in claim 1, wherein the belt fastening device is a patient couch belt fastening device.

22. The belt fastening device as claimed in claim 21, wherein the belt fastening device is a magnetic resonance tomography (MRT) patient couch belt fastening device.
